(19) United States
(12) Patent Application Publication
(10) Pub. No.: US 2006/0054705 A1
(43) Pub. Date: Mar. 16, 2006

(54) Package insert with integrated radio frequency transponder

(75) Inventors: Harold W. Garton, Sugar Hill, GA (US); Andrew M. Holbrook, Atlanta, GA (US)

Correspondence Address: PATENT GROUP GA030-43;GEORGIA-PACIFIC CORPORATION, 133 PEACHTREE STREET, N.E., ATLANTA, GA, 30303-1847, US

(73) Assignee: Georgia-Pacific Corporation, Atlanta, GA (US)

(21) Appl. No.: 11/220,932

(22) Filed: Sep. 7, 2005

Related U.S. Application Data
(60) Provisional application No. 60/607,759, filed on Sep. 8, 2004.

(51) Int. Cl. G06K 13/063; G06F 7/00; G08B 13/14

(52) U.S. Cl. 235/485; 340/572.1; 340/572.8; 700/225

(57) ABSTRACT

A low cost single or multiple use package insert device having an attached radio frequency transponder that, when selectively or randomly inserted into a shipping container, provides a low cost method to provide auto-identification attributes of the container via a wireless technology, such as RFID, for tracking and monitoring of shipping containers through the supply chain.

### BACKGROUND OF THE INVENTION

This application claims the benefit of U.S. Provisional Patent Application No. 60/607,759 filed Sep. 8, 2004.

### FIELD OF THE INVENTION

The present invention relates to a device containing a radio frequency transponder (“RF transponder”). More particularly, the invention relates to a low cost, simple method to integrate an RF transponder within any shipping container to provide auto-identification attributes of the container via a wireless technology (e.g., RFID) for tracking and monitoring of shipping containers through the supply chain.

### DESCRIPTION OF THE RELATED ART

Manufacturers typically distribute products in fiberboard shipping containers, which are commonly tracked by the use of bar code technology as they move through the supply chain. The use of existing automatic identification technologies, such as radio frequency identification (“RFID”), are currently being evaluated by many large consumer packaged goods manufacturers and mass retailers for use in tracking goods through the supply chain. Seen as a lower cost method to acquire data, maintain proper inventory levels and reduce product loss, the use of RFID technologies in the supply chain is expected to increase over the next few years.

The use of RFID technologies in the tracking of goods through the supply chain requires that an RF transponder be attached to the item, its container, or both. Methods to achieve this could include affixing a label containing an RF transponder to the inside or outside of the shipping container or integrating the RF transponder within the container material itself (e.g., within the layer of a corrugated fiberboard blank as described in U.S. Pat. No. 6,667,092 entitled “RFID Enabled Corrugated Structures” issued to Brollier et al.). Both of these methods, however, may not be cost-effective for manufacturers, as they each may require considerable investment in equipment (e.g. RFID label applicators), additional labor for manual label application, as well as significant process changes.

A degree of urgency to develop and implement such technologies is being driven by recent RFID mandates from large companies or entities such as Albertsons, Inc., Wal-Mart Stores Inc., Target Corporation, Best Buy Co., Inc. and by the U.S. Department of Defense. These entities' RFID mandates commonly require their suppliers to provide RF transponders on every case and pallet of goods delivered to them by a certain date. For example, Albertsons Inc., Wal-Mart, and Target each have mandates for their top suppliers to comply during 2005, and all other suppliers are required to comply by the end of 2006.

Accordingly, the need exists for a low cost, simple method to integrate an RF transponder within any container to enable the use of wireless tracking and monitoring of products through the supply chain.

### SUMMARY OF THE INVENTION

An object of the present invention is to provide a low cost, simple method to integrate an RF transponder within any container to provide auto-identification attributes of the container via a wireless technology (e.g., RFID) for tracking and monitoring of products through the supply chain.

Another object of the present invention is to provide a small, compact section of material having an attached RF transponder that, when inserted into a container, provides a low cost method to provide auto-identification attributes of the container via a wireless technology, such as RFID.

Another object of the present invention is to provide an RF transponder suitable for use with a randomly or selectively placed separate component to provide auto-identification attributes of the container via a wireless technology, such as RFID. A selectively placed separate component could be configured to fit a specific location within a shipping container, such as a shipping container length or width panel element, a shipping container divider or partition element, or with a shipping container die-cut element or a shipping container layer pad element to provide auto-identification attributes of the container via a wireless technology, such as RFID.

Still another object of the present invention is to provide an RF transponder suitable for use with a randomly or selectively placed separate component to provide auto-identification attributes of the container via a wireless technology, such as RFID. A selectively placed separate component could be configured to fit a specific location within a shipping container and could be placed via manual or mechanized insertion, and eliminate the need for expensive and/or labor intensive label application equipment for existing container production lines, and thereby reducing costs.

These and other objects are achieved by providing a device comprising an RF transponder affixed or attached to, or embedded within, a section of material, the dimensions of which can be designed to selectively fit the inside of a shipping container, or may be of relatively small size to be placed randomly or selectively inside the shipping container. When the device is placed within a shipping container, information such as company, product and case number data, can be suitably programmed, or written to the RF transponder in the device by means of RFID readers in the supply chain. Additionally, information programmed or written to the RF transponder can be read by means of RFID readers throughout the supply chain.

### BRIEF DESCRIPTION OF THE DRAWINGS

The various objects, advantages and novel features of the present invention will be best understood by reference to the detailed description of the exemplary embodiments which follows, when read in conjunction with the accompanying drawings, in which:

FIG. 1A illustrates an exemplary package insert with integrated radio frequency transponder in accordance with an embodiment of the present invention;

FIG. 1B illustrates an exemplary package insert with integrated radio frequency transponder for use when randomly placed within a shipping container in accordance with an embodiment of the present invention;

FIGS. 2A and 2B illustrate an exemplary package insert with integrated radio frequency transponder for use within a shipping container's length panel in accordance with another embodiment of the present invention;

FIGS. 2C and 2D illustrate an exemplary package insert with integrated radio frequency transponder for use within a shipping container's width panel in accordance with another embodiment of the present invention;

FIGS. 3A and 3B illustrate a number of exemplary package inserts with integrated radio frequency transponder for use within a shipping container's divider or partition in accordance with another embodiment of the present invention;

FIGS. 4A and 4B illustrate an exemplary package insert of FIG. 3B when used with an example product having a tapered profile;

FIGS. 5A and 5B illustrate an exemplary package insert of FIG. 3B when used with an example product having a cylindrical profile; and

FIG. 6 illustrates an exemplary package insert with integrated radio frequency transponder for use within a shipping container's layer pad(s) in accordance with another embodiment of the present invention.

### DETAILED DESCRIPTION OF THE EXEMPLARY EMBODIMENTS

A number of exemplary embodiments of the present invention will now be described in detail with reference to the annexed drawings. In the drawings, the same or similar elements are denoted by the same reference numerals even though they are depicted in different figures.

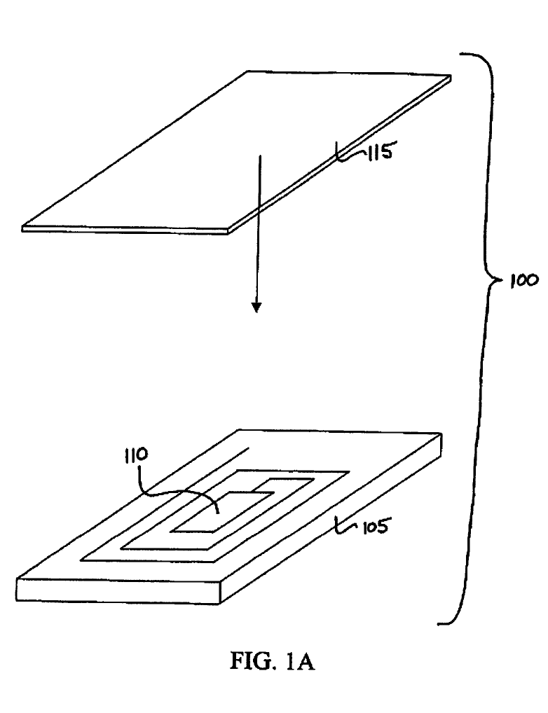

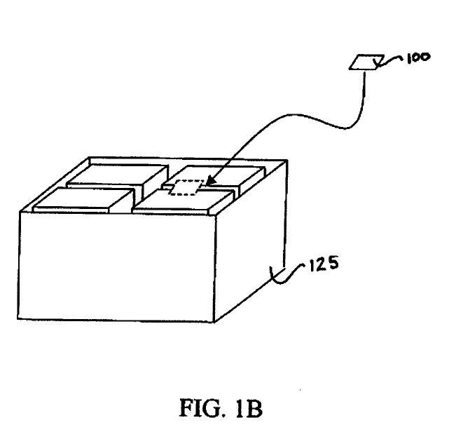

FIG. 1A illustrates an exemplary package insert with integrated radio frequency transponder, or RFID device 100, in accordance with an embodiment of the present invention. In the embodiment of FIG. 1A, the device 100 is provided as a small section of material to which an RFID transponder is affixed. As shown in FIG. 1A, a section of material 105 is provided having an attached radio frequency transponder 110 (“RF transponder”), and an optional protective cover or adhesive piece 115, hereinafter collectively referred to as a “device” 100. When assembled and inserted into a container (not shown), the device 100 provides a low cost method to provide auto-identification attributes of the container via a wireless technology (e.g., RFID).

The material 105 of the device 100 can be comprised of an inexpensive, material such as corrugated fiberboard, cardboard, corrugated plastic, fiberglass, plastic or other suitable material that will not reflect or absorb RF signals. The size and shape of the material 105 can be configured to correspond to the inside dimension of a shipping container (e.g. a shipping container's length or width panel size, a divider or partition, or a layer pad) so as to be selectively placed within the shipping container, or be configured to be randomly or selectively placed inside the shipping container. An RF transponder 110 or similar communication device as known to those skilled in the art, can then be attached to the surface of the material 105 by means of an adhesive (e.g., as a label) or other suitable surface adhesion method, or it can be embedded within the device material 105 by various methods during the device manufacturing process (e.g., corrugation, molding, assembly etc.). Where required, the RF transponder 110 can be protected by a covering material 115 or adhesive for attachment to a shipping container as described in greater detail below.

In an exemplary embodiment of the present invention, the device 100 can be constructed having dimensions as small as possible (given the space requirements of the RF transponder 110 and to reduce additional costs) or as large as required by a specific application. The exemplary embodiment example shown in FIG. 1A has dimensions similar to those of a credit card (e.g., 2 inches by 3 inches, and a thickness of 0.125 inches). This is presented as just one dimension example, however, and still further embodiments can be provided having any number of suitable dimensions.

In use, the substrate material 105, RF transponder 110 and covering material 115 shown in FIG. 1A can be assembled using high speed equipment and shipped in large quantities to product manufacturers or suppliers required to comply with RFID mandates (“customers”). Once received by customers, the assembled device 100 can be easily and quickly inserted into shipping containers, thereby creating RF enabled containers. The device 100 then travels with the container throughout the supply chain. An example method for implementing the embodiment of the present invention shown in FIG. 1A is shown in FIG. 1B and described in greater detail below.

In FIG. 1B, the device 100 is constructed having a small size to facilitate being randomly placed within a container 125, either before, during or after a product is placed within the shipping container. In a first step, the multiple use, returnable RFID tag device 100 of FIG. 1A can be prepared by the integration of a suitable substrate material and an RF transponder. The device 100 can then be received by a customer in a second step, wherein the device 100 is randomly or selectively placed by the customer into a shipping container 125 to be shipped, or is attached to the shipping container with an adhesive in a third step. Where products within the shipping container modify or adulterate RF signals, the user can place the device 100 in an optimum position within the shipping container. Once the shipping container is shipped, the device 100 can be removed from the shipping container and collected for return to the customer in a fourth step. A means can be provided, such as a task specific transponder (not shown), to determine if each device 100 is undamaged in a fifth step, and the returned device 100 can then be repeatedly used until exhausted. Any number of incentives can also be used to ensure return and reuse, such as a monetary refund for returned and undamaged devices.

The device 100 can be randomly placed unattached within a shipping container as shown in FIG. 1B, or can be attached to the shipping container at a desired position. Additionally, the device 100 can be manually placed into or attached to the shipping container, or a mechanized insertion process can be utilized to eliminate the need for expensive and labor intensive label application equipment. In still other embodiments of the present invention described in greater detail below, the device 100 can be provided as an ancillary pad, insert, etc., or provided as an integral component of the shipping container, such as a divider, partition, layer pad, etc.

Depending on the desired use, the device 100 can be designed for single use and disposal thereafter, or can be designed for multiple uses, provided the RF transponder remains viable. The size of the device 100 is broadly adaptable to the required use. The size can be as small as practical (e.g., approximately the size of a credit card), or larger and having a form factor dependant upon the positioning requirements of the RF transponder necessary for optimum RF transponder read and write performance in the supply chain.

The embodiment of the present invention shown in FIG. 1A is most suitable for use with shipping container contents which do not absorb or reflect RF signals. Where products within the shipping container modify or adulterate RF signals, still other embodiments of the present invention, described in greater detail below, can be provided.

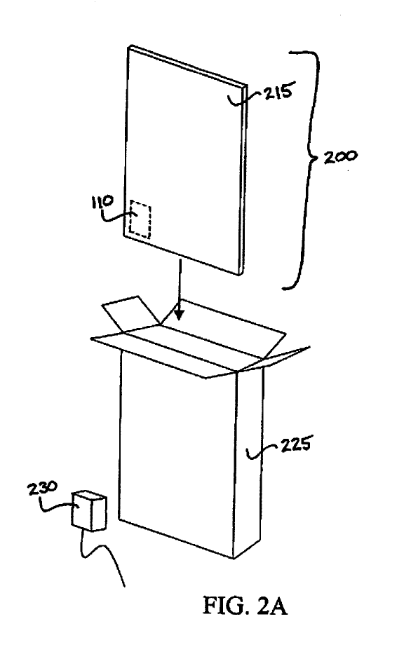

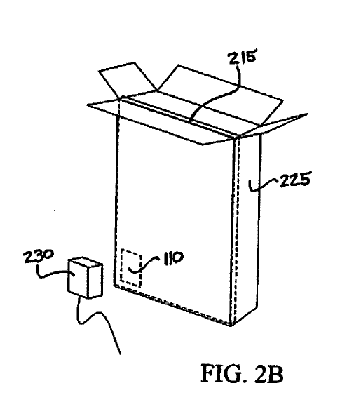

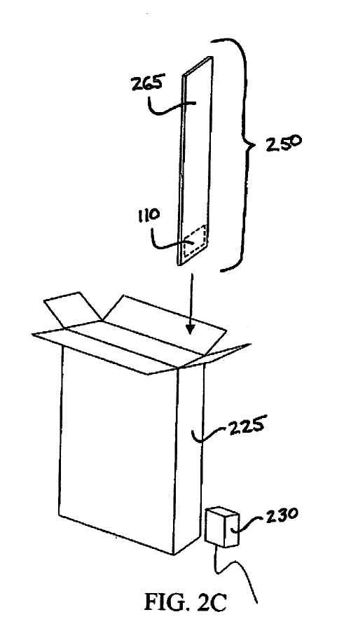

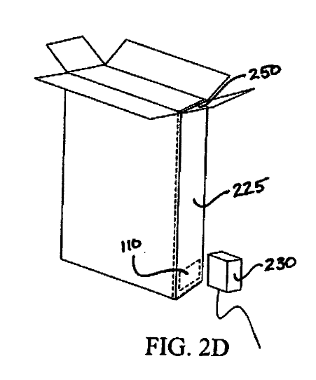

In another exemplary embodiment, the present invention can be constructed substantially the same as described above, yet dimensioned to fit inside a shipping container's length or width panel. FIG. 2A illustrates an exemplary package insert 200 with integrated RF transponder 110 for use within a shipping container's length panel in accordance with another embodiment of the present invention. FIG. 2C illustrates an exemplary package insert 250 with integrated RF transponder 110 for use within a shipping container's width panel in accordance with another embodiment of the present invention.

In use, a substrate material 215 and 265, and an RF transponder (and optional protective cover) 110, can be assembled into the device 200 shown in FIG. 2A or a similar device 250 shown in FIG. 2B, using high-speed equipment, and then shipped in large quantities to customers. Once received by the customer, the devices 200 and 250 can be placed, manually or by mechanized means, by the customer inside a shipping container's length or width panel, respectively, such as the slotted container 225 and shown in FIGS. 2B and 2D, thereby creating an RF enabled shipping container. The devices 200 and 250 then travel with the shipping container 225 throughout the supply chain. An example method for implementing the embodiment of the present invention shown in FIGS. 2A and 2C is described in greater detail below.

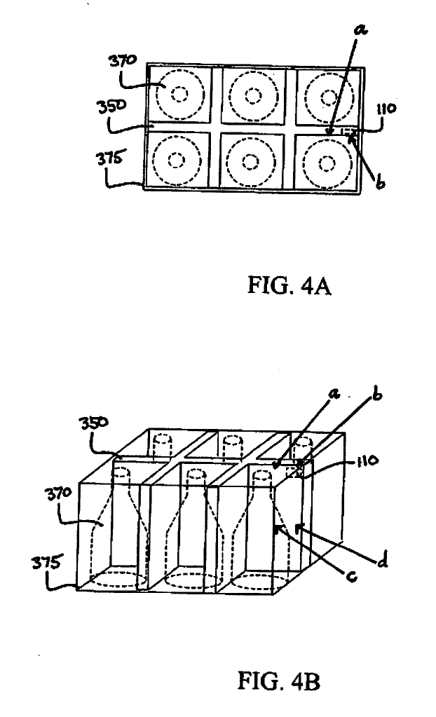

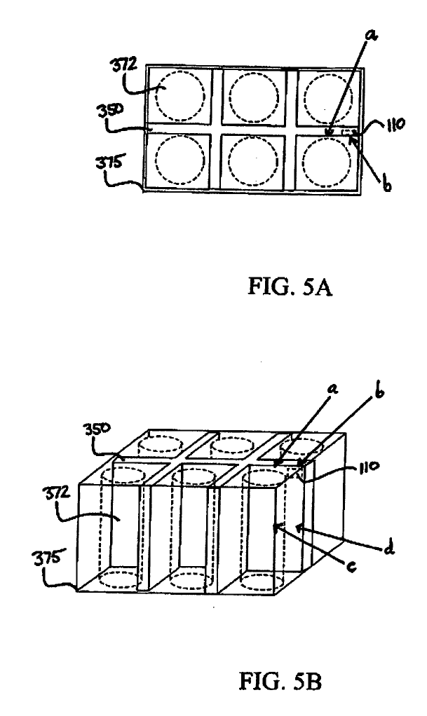

In the example embodiment shown in FIGS. 2A and 2C, the RF transponder 110 is shown at a specific position on the substrate material 215 and 265. Although the RF transponder 110 can be positioned anywhere on the substrate material, the example shown in FIGS. 2A and 2C, illustrate an embodiment of the present invention in which the RF transponder 110 can be specifically positioned as desired. The specific position can be required for a number of reasons. For example, where the product (not shown) within the container 225 excessively reflects or absorbs RF signals, the user can be required to place the RF transponder 110 in an optimum position within the container for optimum RF transponder read and write performance. This is discussed in greater detail below in reference to FIGS. 4 and 5. Still another reason for providing the RF transponder 110 at a specific position is to provide easy access by a reader 230, as shown in FIGS. 2B and 2D.

FIG. 2B shows the device 200 when placed into a container 225, and FIG. 2D shows the device 250 when placed into a container 225. The dimensions of the device 200 can be configured to allow manual or mechanized placement along a length panel (e.g., having substantially length panel dimensions). In a similar fashion, the dimensions of the device 250 can be configured to allow manual or mechanized placement by the customer along a width panel (e.g., having substantially width panel dimensions). Placement and use can be achieved as described below.

In a first step, the multiple use, returnable RFID tag device 200 of FIG. 2A can be prepared by the integration of a suitable substrate material 215 and an RF transponder 110 as described above. The device 200 can then be received by a customer in a second step, wherein the device 200 is placed, manually or by mechanized means, by the customer along a length panel within a shipping container 225 to be shipped in a third step, allowing the device 200 to communicate with a reader 230 through the alignment and/or proximity created by the specific placement of the RF transponder 110 on the substrate material 215. Once the product is shipped, the device 200 can be removed from the shipping container 225 and collected for return to the customer in a fourth step. As noted above, a means can be provided, such as a task specific transponder (not shown), to determine if each device 200 is undamaged in a fifth step, and the returned device 200 can then be repeatedly used until exhausted.

The placement and use of the device 250 is substantially the same as the placement and use of the device 200 with one exception. In the second step, the device 250 can be placed, manually or by mechanized means, by the customer along a width panel within a shipping container 225 to be shipped in a third step, allowing the device 250 to communicate with a reader 230 through the alignment and/or proximity created by the specific placement of the RF transponder 110 on the substrate material 265.

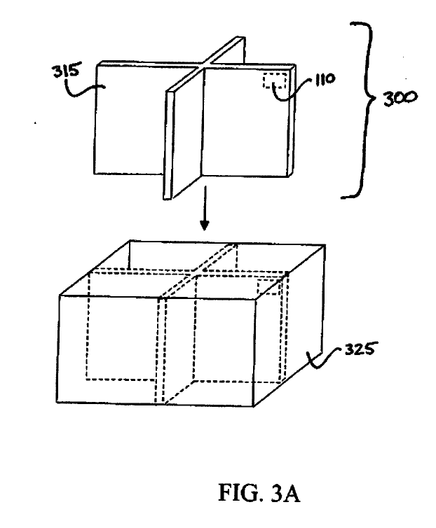

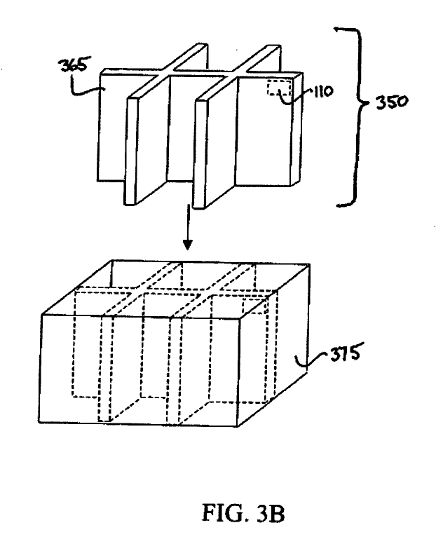

In another exemplary embodiment, the present invention can be constructed substantially the same as described above, yet provided as a package divider or partition component. FIGS. 3A and 3B illustrate examples of exemplary package inserts with integrated RF transponders for use as a divider or partition in accordance with another embodiment of the present invention.

In use, a substrate material 315 and 365, and an RF transponder (and optional protective cover) 110, can be assembled into the device 300 shown in FIG. 3A, or a similar device 350 shown in FIG. 3B, using high-speed equipment and shipped in large quantities to customers. Once received by customers, the devices 300 and 350 can be placed, manually or by mechanized means, by the customer into shipping containers, such as the shipping containers 325 and 375 shown in FIGS. 3A and 3B, respectively, thereby creating an RF enabled shipping container. The devices 300 and 350 then travel with the shipping containers throughout the supply chain. An example method for implementing the embodiment of the present invention shown in FIGS. 3A and 3B is described in greater detail below.

In a first step, the multiple use, returnable RFID tag device 300 of FIG. 3A, and device 350 of FIG. 3B, can be prepared by the integration of a suitable substrate material 315 and 365, and an RF transponder 110 into a divider or partition member. The divider or partition can be provided in any number of configurations, from simple to complex, and those shown in FIGS. 3A and 3B are provided as examples. The devices 300 and 350 can then be received by a customer in a second step, wherein the devices 300 and 350 are placed, manually or by mechanized means, by the customer into a shipping container 325 and 375 to be shipped in a third step.

As in the example embodiment shown in FIGS. 2A and 2C, the RF transponder 110 in FIGS. 3A and 3B is shown at a specific position on the substrate material 315 and 365. Although the RF transponder 110 can be positioned anywhere on the substrate material, the examples shown in FIGS. 3A and 3B illustrate embodiments of the present invention in which the RF transponder 110 can be specifically positioned as necessary for optimum RF transponder read and write performance for shipping container's containing a product (not shown) which may excessively reflect or absorb RF signals. For example, liquid or metal products can require specific RF transponder placement on or within the shipping container for optimum read and write performance. The use of divider or partition embodiments of the present invention, ensure proper placement of the RF transponder can be easily achieved, which may not be consistently possible using the small, randomly placed embodiment of the present invention shown in FIGS. 1A and 1B.

For example, FIGS. 4A and 4B illustrate an exemplary package insert of FIG. 3B when used with an example product that excessively reflects or absorbs RF signals contained within the shipping container and having a tapered profile, and FIGS. 5A and 5B illustrate an exemplary package insert of FIG. 3B when used with an example product having a cylindrical profile. The profile of the product in this example is presented to illustrate a situation in which the product adversely affects RF signals, and transponder 110 position is selected accordingly.

FIG. 4A is a top view of the insert of FIG. 3B, and FIG. 4B is a perspective view of the insert of FIG. 3B, each illustrating a product 370 that excessively reflects or absorbs RF signals contained within the shipping container 375. In the example shown, the product 370 comprises a large diameter, cylindrical body for a substantial length of the product, which is then reduced in diameter at a top end. Where this large diameter, cylindrical body is in close proximity to the insert 350, the product 370 adversely affects RF signals. Therefore, preferably, the transponder 110 is placed near the top of the product 370, where the large diameter, cylindrical body of the product 370 is reduced to a small diameter, cylindrical neck and top. At such a position near the top, the transponder 110 could be safely placed at points labeled a or b, which are some distance from the top of product 370. Point c however, is a poor choice for transponder 110 position, as the position c is in close proximity to the large diameter, cylindrical body and therefore, subject to RF interference. However, point d would also be an acceptable choice for transponder 110 position, as the position d is some distance from the large diameter, cylindrical body, given the curved circumference of the product 370. In some cases, where there is no reduction in product diameter and therefore, points a and b are substantially equivalent to points c and d, respectively, points b and d are both preferred choices for transponder 110 position.

For example, FIG. 5A is a top view of the insert of FIG. 3B, and FIG. 5B is a perspective view of the insert of FIG. 3B, each illustrating a product 372 that excessively reflects or absorbs RF signals contained within the shipping container 375. In the example shown, the product 372 comprises a large diameter, cylindrical body for an entire length of the product. Where this large diameter, cylindrical body is in close proximity to the insert 350, the product 372 would adversely affect RF signals. Therefore, preferably, the transponder 110 is placed at a point far from the product 372, where the curved circumference of the large diameter, cylindrical body of the product 372 creates a gap. At such a position, the transponder 110 could be safely placed at points labeled b or d. Points a and c however, are poor choices for transponder 110 position, as the positions are in close proximity to the large diameter, cylindrical body and therefore, subject to RF interference.

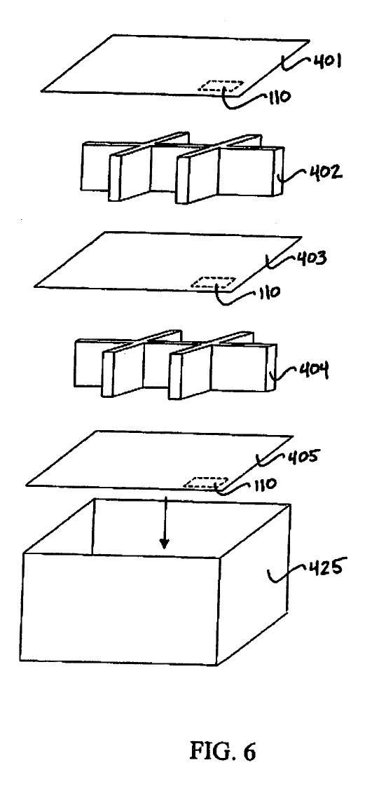

In another exemplary embodiment, the present invention can be constructed substantially the same as described above, yet provided as an ancillary or layer pad component. FIG. 6 illustrates an example of an exemplary ancillary or layer pad with integrated RF transponder for use in accordance with another embodiment of the present invention.

In FIG. 6, layer pads 401, 403 and 405 are shown above and below dividers 402 and 404, and are provided as one example of the use of an exemplary embodiment of the present invention. One or multiple layer pads may be required to adequately protect the product(s) within the shipping container during shipment. If multiple layer pads are required, only one of the layer pads 401, 403, and 405 would include a transponder 110, which can be further placed in a specific position on the pad to avoid RF interference as noted and described in detail above. Each layer pad 401, 403 and 405 can be configured having dimensions substantially conforming to those of the shipping container (e.g., length and width panels) as required by the application. Location of the layer pad(s) may be anywhere within the shipping container as may be required for proper product protection during shipping (e.g. placed at the bottom, middle, between layers of goods, or top of the product). Placement and use can be achieved as described below.

In a first step, the multiple use, returnable RFID tag devices 401, 403 and 405 of FIG. 6 can be prepared by the integration of a suitable substrate material, and an RF transponder into an ancillary or layer pad. The pads can then be received by a customer in a second step, wherein the device 401, 403, and/or 405 are placed, manually or by mechanized means, by the customer into a shipping container 425 to be shipped in a third step.

The above exemplary embodiments of the present invention can further be provided with various odd-sized package components. Such components are typically produced by a flat or rotating die cutting cylinder that can produce one or multiple package components with each turn, and are shipped flat for subsequent assembly by customers into finished shipping containers. In this case, it is impractical to apply an RFID label to each package component due to speed and space restrictions involved with the typical die cutting machine processes. That is, there are difficulties and high costs associated with implementing RFID label applicators at production speeds. The embodiments of the present invention described above, however, allow any customer to easily convert die-cut package components into an RFID enabled shipping container either prior to product filling, or after product filling. The customer can easily create an RFID enabled shipping container through the mechanized or manual insertion of the embodiments of the present invention described above into virtually any shipping container configuration. This provides a degree of flexibility as required by the product to be placed within the shipping container. For example, where products excessively reflect or absorb RF signals, the customer will be required to place the RF transponder in a specific position within or on the container for optimum RF transponder read and write performance. Products that excessively reflect or absorb RF signals contained within the shipping container, such as liquids and metals may require specific RF transponder placement, such as near the top of or at a point furthest away from a circular containment bottle to prevent interference with RF communications. In use, the embodiments described above can be provided with a form factor to ensure the RF transponder placement is near the top of the shipping container and/or in a position for optimum RF transponder read and write performance.

Given the flexibility allowed by the embodiments of the present invention described above, the many different methods required by the prior art to adhere or embed RF transponders, labels or tags on or in shipping containers are no longer required. Accordingly, the need for specialized equipment (e.g., expensive production-line RFID label applicators) for affixing labels or tags containing RF transponders into or onto shipping containers are also no longer required.

The embodiments of the present invention described above provide an efficient system and method to enable radio frequency shipping container tracking and monitoring by simply placing the device into the shipping container prior to use, and thereby eliminating the requirement of specialized equipment associated with adhering and/or embedding RF transponders, labels or tags.

The advantages of the embodiments of the present invention further include the ability to monitor and track products in shipping containers with minimal product contact through wireless communication. As the product moves from location to location in the supply chain, the device communicates manufacturer, product and case number information to any number of locations via transceivers (“readers”) positioned throughout the supply chain. If so desired, the devices can be easily retrieved and reused a number of times.

The exemplary embodiments of the present invention described above eliminate the need for costly and complex high-speed equipment which would be required to apply RF transponders, labels or tags to shipping containers or insert the RF transponder, label or tag into shipping containers. The embodiments further eliminate the need to manually apply RF transponders, labels or tags to shipping containers, which can adversely affect throughput and increase expenditures of labor and allocation of production space. Additionally, the embodiments eliminate the requirement for packaging suppliers to provide packaging which includes the RF transponders, tags or labels. Such requirements involve a large degree of capital investment by the packaging supplier and can not entirely eliminate the potential for damage of the adhered RF transponder, label or tag prior to receipt by the customer, resulting in higher total costs to the customer. The above embodiments can be efficiently manufactured using a limited number of strategically located high-speed equipment lines and cost-effectively shipped in large quantities to customers, which can then apply each to a shipping container. Therefore the manufacturer is no longer required to apply or add RF transponders, labels or tags to containers.

As noted above, the embodiments of the present invention further substantially satisfy RFID mandates being implemented by companies such as Albertsons, Inc., Wal-Mart Stores Inc., Target Corporation, Best Buy Co., Inc. and by the U.S. Department of Defense. The embodiments provide a means to easily satisfy the requirement for RFID transponders, labels or tags by retailers to track shipping containers through a supply chain and provide auto-identification.

The present invention has been described with reference to exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way.

Therefore, having thus described the invention, at least the following is claimed:

1. A method for wireless tracking and monitoring of products through a supply chain, comprising:
providing a radio frequency transponder;
placing the radio frequency transponder in association with a shipping container;
placing product to be shipped in the shipping container;
shipping the shipping container to a destination location; and
returning the radio frequency transponder to a first location to collect data from the radio frequency transponder.

2. The method of claim 1 wherein the radio frequency transponder is connected to an insert that is placed in the shipping container.

3. The method of claim 2 wherein a protective cover is located over the radio frequency transponder.

4. The method of claim 1 wherein the radio frequency transponder is reusable.

5. The method of claim 1 wherein the product to be shipped does not substantially reflect or absorb radio frequency signals.

6. The method of claim 1 wherein the radio frequency transponder is located along a length panel or a width panel of the shipping container.

7. The method of claim 1 wherein the radio frequency transponder is located along an internal partition of the shipping container.

8. A method for wireless tracking and monitoring of products through a supply chain, comprising:
providing a radio frequency transponder;
placing the radio frequency transponder in association with a shipping container;
placing product to be shipped in the shipping container;
reading data from or writing data to the radio frequency transponder;
shipping the shipping container to a desired location; and
collecting data from the radio frequency transponder after the shipping container arrives at the desired location.

9. The method of claim 8 wherein the radio frequency transponder is connected to an insert that is placed in the shipping container.

10. The method of claim 9 wherein a protective cover is located over the radio frequency transponder.

11. The method of claim 8 wherein the radio frequency transponder is reusable.

12. The method of claim 8 wherein the product to be shipped does not substantially reflect or absorb radio frequency signals.

13. The method of claim 8 wherein the radio frequency transponder is located along a length panel or a width panel of the shipping container.

14. The method of claim 8 wherein the radio frequency transponder is located along an internal partition of the shipping container.

15. A method for wireless tracking and monitoring of products through a supply chain, comprising:
placing a radio frequency transponder in a shipping container;
reading data from or writing data to the radio frequency transponder;
placing product to be shipped in the shipping container; and
reading data from the radio frequency transponder after product has been placed in the shipping container.

16. The method of claim 15 wherein the radio frequency transponder is located in the shipping container such that the product to be shipped does not substantially reflect or absorb radio frequency signals.

17. The method of claim 16 wherein a protective cover is located over the radio frequency transponder.
